(19) United States
(12) Patent Application Publication
(10) Pub. No.: US 2012/0001590 A1
(43) Pub. Date: Jan. 5, 2012

(54) Dual-sided wireless charging device

(76) Inventor: Ming-Hsiang Yeh, Taipei City (TW)

(21) Appl. No.: 13/067,820

(22) Filed: Jun. 29, 2011

(30) Foreign Application Priority Data
Jul. 2, 2010 (TW) 099212668

(51) Int. Cl. H02J 7/00

(52) U.S. Cl. 320/108

(57) ABSTRACT

A dual-sided wireless charging device includes a main body, which includes a seat, a coupling member, and a power member. The seat and the coupling member are mounted to each other at a right angle. The coupling member has a first surface and a second surface, which are respectively provided with a transmitter circuit, whereby at least one electronic device having a receiver circuit is attachable to the first surface and/or the second surface to perform charging operation on both surfaces to thereby increase charging efficiency and reduce expense.

### FIELD OF THE INVENTION

The present invention relates to a wireless charging device, and in particular to a dual-sided wireless charging device applicable to portable electronic products or other electronic products.

### BACKGROUND OF THE INVENTION

With the continuous progress of technology and science, the demand for electronic devices by general consumers is increasingly upgraded, especially for consumer electronic products. Electronic devices, which were bulky in size, such as optic disk players, household telephones, and desk-top computers, are being changed to compact and portable electronic products of high performance, such as multimedia player (for example MPEG Audio Layer-3, MP3), mobile phones, and notebook computers, all leading to a more efficient life for human beings.

Most of such portable electronic products, including the multimedia players and mobile phones, are powered by rechargeable batteries or cells, such as nickel hydride battery and lithium battery. The rechargeable battery is re-chargeable through a charging device or charger, which is composed of a charging seat and an electrical connector. The charging seat forms a charging chamber in which the rechargeable battery is positioned, while the electrical connector is set in connection with a power socket, such as a wall outlet to supply a required voltage or current to charge the rechargeable battery. On the other hand, the electronic device, such as notebook computer, is provided with an adaptor that is electrically connectable with the wall outlet, whereby the adaptor that receives electrical power from the wall outlet supplies a required voltage or current to the notebook computer. Since the portable electronic products must be powered through the adaptor or by a rechargeable battery, those who attempt to carry these products outdoors must also carry various adaptors or chargers. This is very inconvenient for the users of the products and makes the use inconvenient. Further, the charging device or the adaptor must use connection wires to transmit electrical power for charging the rechargeable battery. This limits the range where the charging device or the adaptor is useful.

To overcome the above discussed problem, a wireless charging device was proposed, which comprises a wireless circuit formed on a surface of the wireless charging device to receive a portable electronic product to be placed thereon for charging. The wireless charging device has an opposite surface on which a magnetic conduction plate or a magnetic shield plate is mounted to prevent magnetic leakage from interfering with or affecting surrounding metal articles or other articles. However, since the wireless charging device comprises the wireless circuit on only one surface thereof with the opposite surface being provided with a magnetic conduction plate or a magnetic shield plate, charging operation can only be performed on said one surface and the charging efficiency is low.

In view of such problems, the present invention aims to provide a dual-sided wireless charging device that improves charging efficiency and is not subjected to limitation of use range.

### SUMMARY OF THE INVENTION

An objective of the present invention is to provide a dual-sided wireless charging device, which allows of performance of charging operation on both surfaces in order to increase charging efficiency.

Another objective of the present invention is to provide a dual-sided wireless charging device, which allows charging operation to be performed in a wireless manner in order to alleviate the limitation of range of use.

To achieve the above objectives, the present invention provides a dual-sided wireless charging device that is applicable to at least one electronic device comprising a receiver circuit. The dual-sided wireless charging device comprises: a main body, which comprises a seat, a coupling member, and a power member. The seat and the coupling member are mounted to each other at a right angle. The coupling member has a first surface and a second surface, to which the electronic devices are respectively attachable; and a transmitter circuit, which is arranged in the coupling member. The power member supplies electrical power to the transmitter circuit to allow the transmitter circuit to convert the electrical power into an alternate-current signal, which is transmitted by the transmitter circuit to the receiver circuit of the electronic device in a wireless manner. The receiver circuit converts the alternate-current signal into electrical power for performance of charging operation. As such, charging operation can be performed on both surfaces to thereby increase charging efficiency and reduce expense. Further, charging can be performed without respective connection with various chargers, thereby eliminating the problem of limited range of use caused by wired connection with the chargers, and ease of use is realized.

### BRIEF DESCRIPTION OF THE DRAWINGS

The present invention will be apparent to those skilled in the art by reading the following description of preferred embodiments thereof with reference to the drawings, in which:

FIGS. 1A-1C are perspective views illustrating dual-sided wireless charging devices according to the present invention;

FIGS. 2A-2D are perspective views illustrating use of the dual-sided wireless charging device according to the present invention; and

FIGS. 3A-3D are circuit diagrams of the dual-sided wireless charging device according to the present invention.

### DETAILED DESCRIPTION OF THE PREFERRED EMBODIMENTS

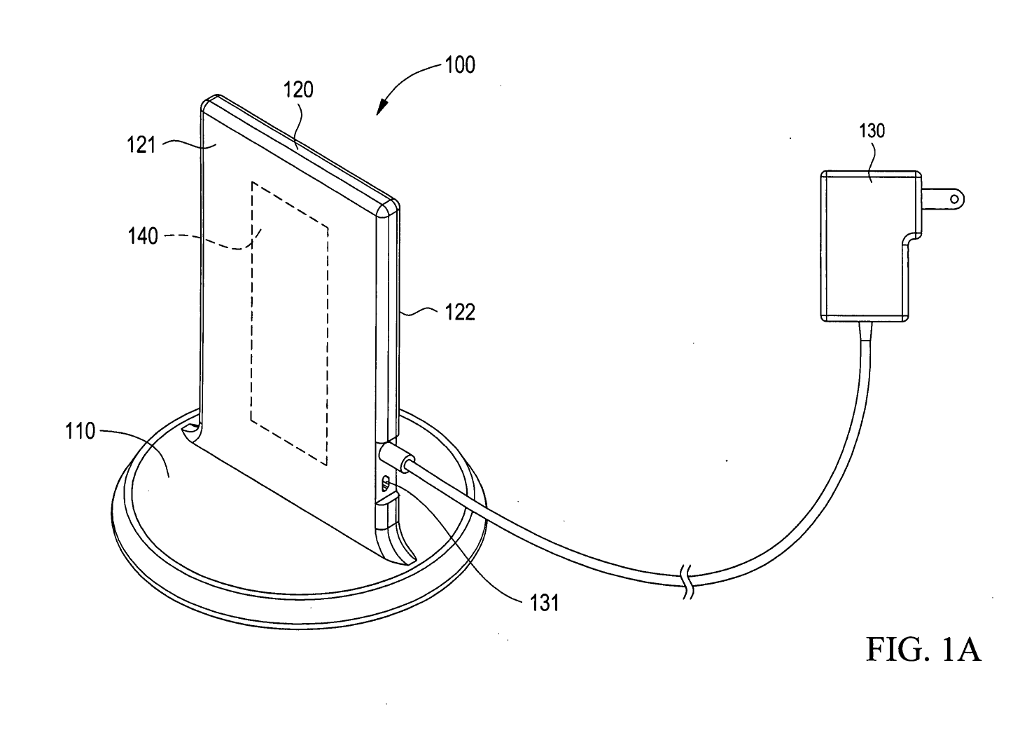

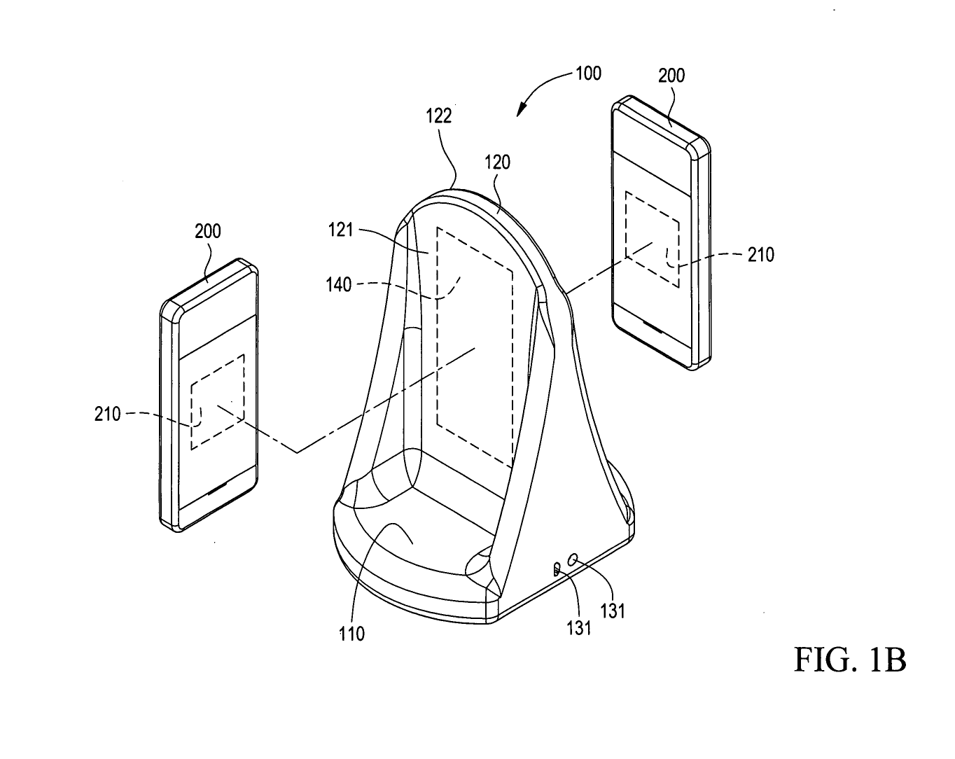

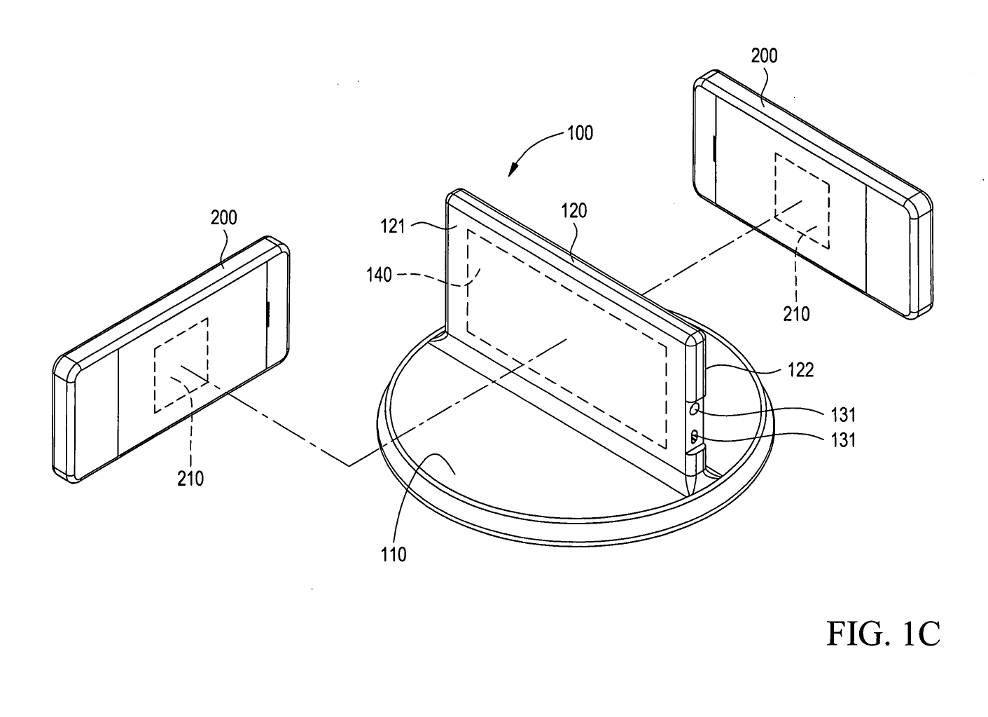

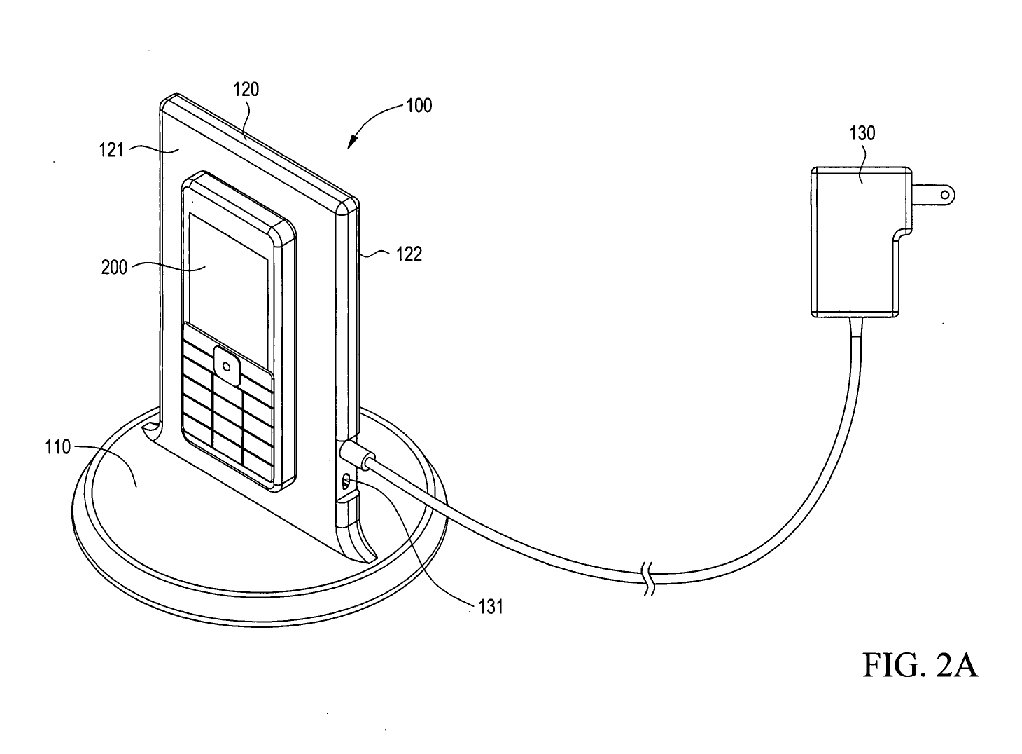

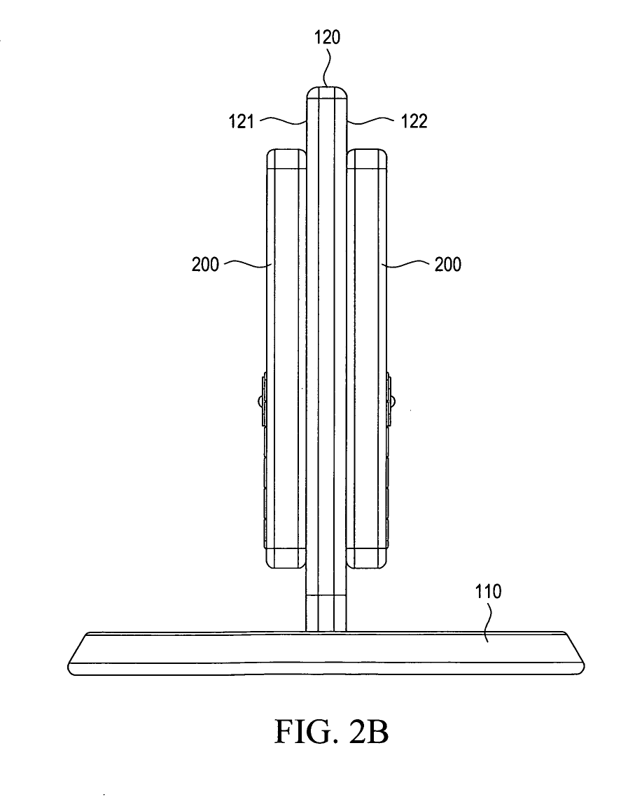

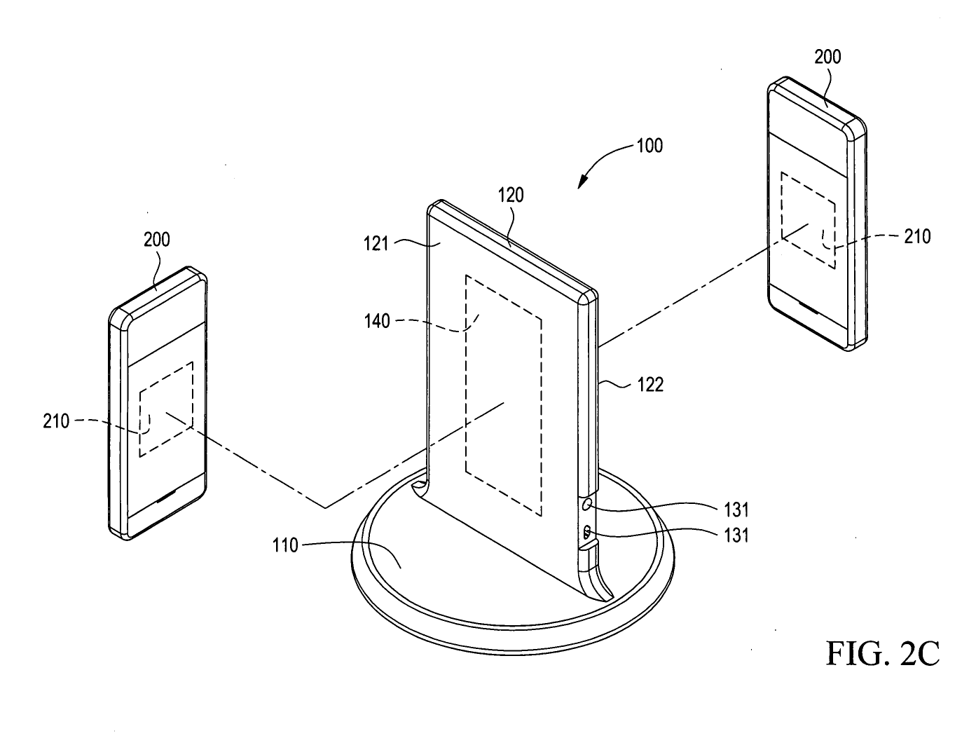

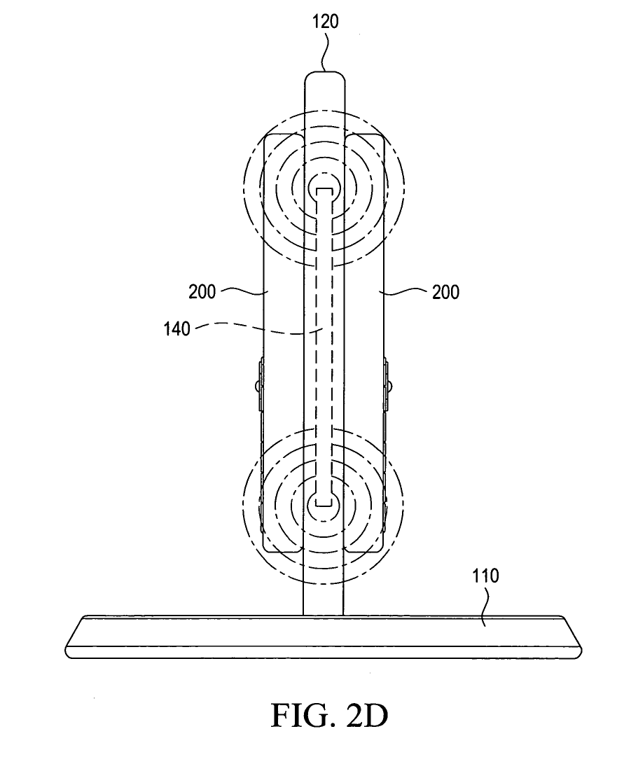

With reference to the drawings and in particular to FIGS. 1A to 3D, which are respectively perspective views of a dual-sided wireless charging device according to an embodiment of the present invention, perspective views illustrating use of the dual-sided wireless charging device according to the present invention, and circuit diagrams of the dual-sided wireless charging device according to the present invention, the dual-sided wireless charging device according to the present invention comprises a main body 100 and a transmitter circuit 140. A user may place an electronic device 200 that comprises a receiver circuit 210 on the main body 100 for performance of a charging operation through wireless transmission

The main body 100 comprises a seat 110, a coupling member 120, and a power member 130. The coupling member 120 is set in a vertical direction and mounted to the seat 110 at a right angle (as shown in FIG. 1A), or alternately the coupling member 120 and the seat 110 are formed integrally (as shown in FIG. 1B), or alternately the coupling member 120 is set in a horizontal direction and mounted to the seat 110 at a right angle (as shown in FIG. 1C). The coupling member 120 has a first surface 121 and a second surface 122. The coupling member 120 has a lateral side forming at least one power jack 131 (which can be power connection or universal serial bus connection) to receive the power member 130 to fit therein for supply of electrical power to the main body 100. The power member 130 can be for example a separate adapter or an adapter, plug, power cable of another electronic device or a universal serial bus connector. The coupling member 120 comprises the transmitter circuit 140 and is provided with coupling means, such as clip, tying wire, magnet, hook-and-loop fastener, and soft gel, to attach the electronic device 200 to the first surface 121 and/or the second surface 122. The transmitter circuit 140 of the coupling member 120 functions to convert electrical power supplied from the power member 130 into an alternate current (AC), which is then transmitted by the transmitter circuit 140 in a wireless manner to the receiver circuit 210 of the electronic device 200, whereby the receiver circuit 210 converts the alternate current into electrical power that is stored and/or supplied to the electronic device 200.

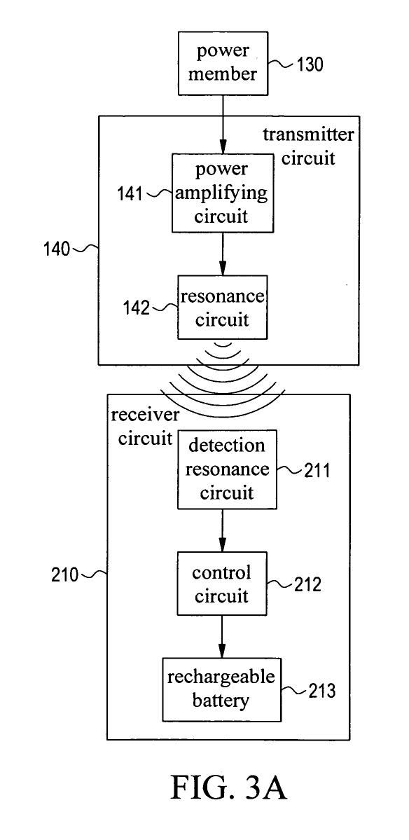

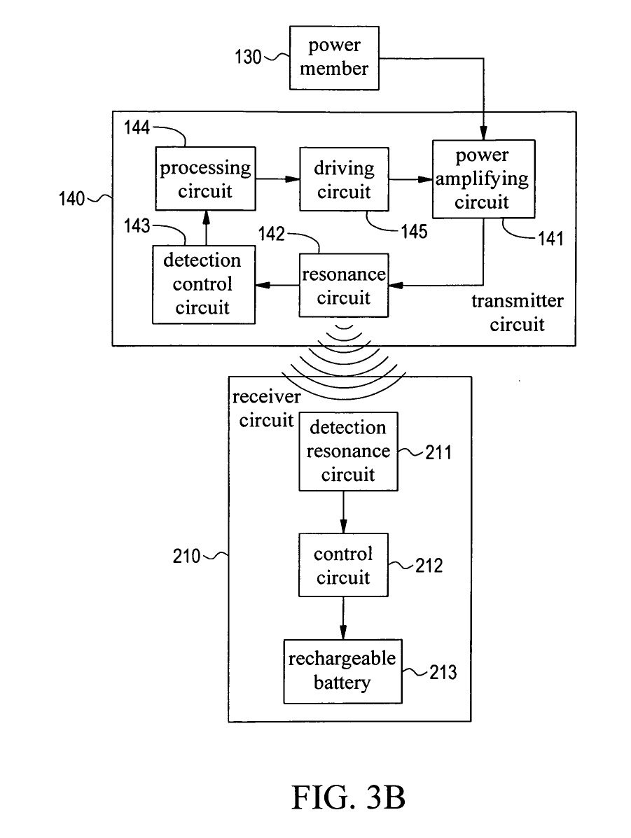

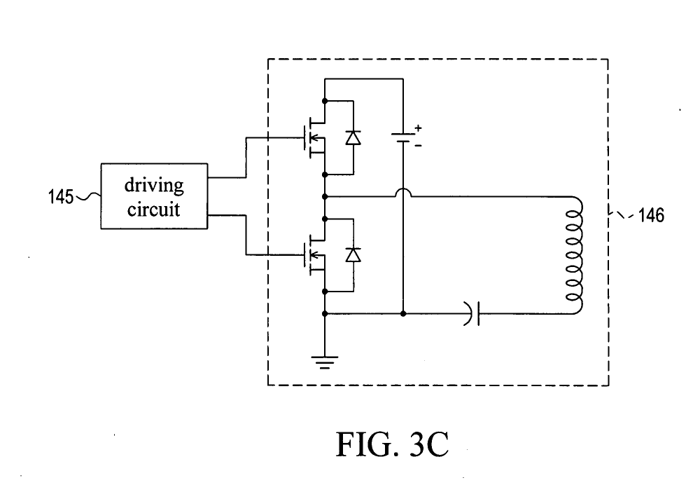

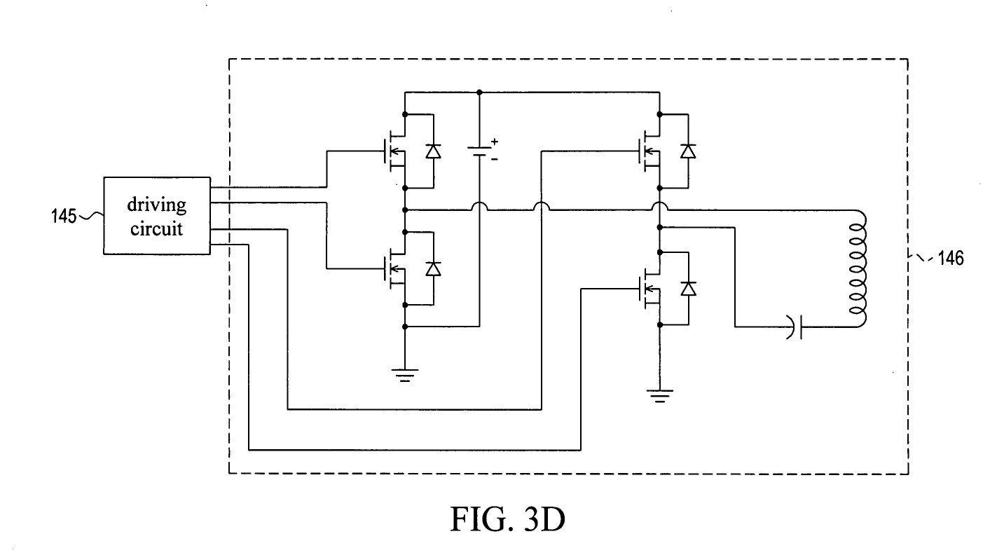

The transmitter circuit 140 comprises a power amplifying circuit 141 connected to the power member 130 and a resonance circuit 142 connected to the power amplifying circuit 141, whereby the power amplifying circuit 141 converts the electrical power supplied from the power member 130 into an AC signal. The AC signal is subjected to amplification by the power amplifying circuit 141 and the amplified AC signal is processed by the resonance circuit 142 to retrieve resonance energy. The AC signal is then transmitted by the resonance circuit 142 to the receiver circuit 210 (see FIG. 3A).

Further, the transmitter circuit 140 may further comprise a detection control circuit 143 connected to the resonance circuit 142, a processing circuit 144 connected to the detection control circuit 143, and a driving circuit 145 connected to the processing circuit 144 and the power amplifying circuit 141, whereby the detection control circuit 143 detects the magnitude of the AC signal transmitted by the resonance circuit 142 and the processing circuit 144, which is pre-provided with a predetermined signal, compares the predetermined signal with the AC signal to generate a frequency regulation signal based on which the driving circuit 145 regulates the signal frequency and thus the power of the power amplifying circuit 141 is regulated for feeding back and controlling the AC signal transmitted by the resonance circuit 142 and providing the AC signal with stabilized power (see FIG. 3B).

Further, the power amplifying circuit 141 and the resonance circuit 142 are both power circuits. Alternatively, the power amplifying circuit 141 and the resonance circuit 142 can be combined as a power integration circuit 146. The resonance circuit 14 comprises a circuit generally composed of at least two metal-oxide-semiconductor field effect transistors (MOSFETs). In other words, the resonance circuit 142 forms a half-bridge power circuit (see FIG. 3C) or a full-bridge power circuit (see FIG. 3D) through electrical connection of the MOSFETs.

The electronic device 200 is for example a portable electronic product, such as a multimedia player and a mobile phone. The receiver circuit 210 of the electronic device 200 can be properly positioned with respect to the transmitter circuit 140 of the coupling member 120 through for example mateable dimple and projection (such as dimple and projection respectively formed in the electronic device 200 and the main body 100), magnetic positioning means (such as positive and negative magnetic poles respectively provided on the main body 100 and the electronic device 200), sound-based positioning means (such as sound generator and sensor respectively provided on the main body 100 and the electronic device 200), light-based positioning means (such as light source and sensor respectively provided on the main body 100 and the electronic device 200). The receiver circuit 210 of the electronic device 200 comprises an detection resonance circuit 211, a control circuit 212 connected to the detection resonance circuit 211, and a rechargeable battery 213 connected to the control circuit 212, whereby the detection resonance circuit 211 detects and receives the AC signal transmitted from the transmitter circuit 140 and the control circuit 212 converts the AC signal received by the detection resonance circuit 211 into electrical power and performs voltage regulation of the electrical power so converted. The electrical power is then stored in the rechargeable battery 213, whereby the rechargeable battery 213 may subsequently supply the electrical power to the electronic device 200.

In the embodiment illustrated, the power jack 131 of the main body 100 is connected to the power member 130, whereby when a user wishes to charge two electronic devices 200 (such as mobile phones), the user couples the electronic devices 200 to the first surface 121 and the second surface 122 of the coupling member 120, so that the electrical power is supplied from the power member 130 to the transmitter circuit 140 and the transmitter circuit 140 converts the electrical power into an AC signal that is then transmitted by the transmitter circuit 140 to the receiver circuit 210 of each electronic device 200 to electrically charge the receiver circuits 210 and thus supply electrical power to the electronic devices 200. Through the distribution of magnetic force lines, dual-sided charging operation can be realized (as shown in FIG. 4) and no magnetic conduction plate or magnetic shield plate is needed for shielding or conduction of magnetism. Further, instantaneous charging can be simultaneously performed on at least one portable electronic device thereby realize increased charging efficiency with reduced expense. Further, charging can be performed without respective connection with various chargers, thereby eliminating the problem of limited range of use caused by wired connection with the chargers, and advantages such as easy carrying and storage are realized.

In summary, the present invention provides a dual-sided wireless charging device, which comprises a main body 100 comprising a seat 110, a coupling member 120, and a power member 130. The seat 110 and the coupling member 120 are coupled to each other at a right angle. The coupling member 120 has a first surface 121 and a second surface 122. The coupling member 120 comprises a transmitter circuit 140. When a user wishes to charge at least one electronic device 200 that comprises a receiver circuit 210, the user couples the electronic device(s) 200 to the first surface 121 and/or the second surface 122, whereby electrical power is supplied from the power member 130 to the transmitter circuit 140 and the transmitter circuit 140 converts the electrical power into an AC signal that is then transmitted by the transmitter circuit 140 to the receiver circuit 210 of each electronic device 200 to electrically charge the receiver circuits 210 and thus supply electrical power to the electronic devices 200. With such a dual-sided arrangement, instantaneous charging can be simultaneously performed on at least one portable electronic device to thereby increase charging efficiency and reduce expense. Further, charging can be performed without respective connection with various chargers, thereby eliminating the problem of limited range of use caused by wired connection with the chargers, and advantages such as easy carrying and storage are realized. As such, the convenience of use is improved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A dual-sided wireless charging device adapted to be applied to at least one electronic device comprising a receiver circuit, the dual-sided wireless charging device comprising:
a main body, which comprises a seat, a coupling member, and a power member, the seat and the coupling member being coupled to each other, the coupling member having a first surface and a second surface, the electronic device being selectively attachable to the first surface or the second surface; and
a transmitter circuit, which is arranged in the coupling member, the power member supplies electrical power to the transmitter circuit to allow the transmitter circuit to convert the electrical power into an alternate-current signal, which is transmitted by the transmitter circuit to the receiver circuit of the electronic device in a wireless manner, the receiver circuit converting the alternate-current signal into electrical power for performance of charging operation.

2. The dual-sided wireless charging device as claimed in claim 1, wherein the coupling member and the electronic device are attached to each other through one of clip, tying wire, magnet, loop-and hoop fastener, and soft gel.

3. The dual-sided wireless charging device as claimed in claim 1, wherein the transmitter circuit of the coupling member and the receiver circuit of the electronic device are positionable with respect to each other through one of mateable dimple and projection, magnetic positioning, sound-based positioning, and light-based positioning.

4. The dual-sided wireless charging device as claimed in claim 1, wherein the transmitter circuit comprises a power amplifying circuit and a resonance circuit, the power amplifying circuit being connected to the power member, the power amplifying circuit converting the electrical power supplied from the power member into an alternate-current signal and amplifying the alternate-current signal, the resonance circuit being connected to the power amplifying circuit, the resonance circuit transmitting the alternate-current signal that is amplified by the power amplifying circuit to the receiver circuit.

5. The dual-sided wireless charging device as claimed in claim 4, wherein the transmitter circuit further comprises a detection control circuit, a processing circuit, and a driving circuit, the detection control circuit being connected to the resonance circuit, the detection control circuit detecting magnitude of the alternate-current signal transmitted by the resonance circuit, the processing circuit being connected to the detection control circuit, the processing circuit being provided with a predetermined signal, the processing circuit comparing the predetermined signal with the alternate-current signal to generate a frequency regulation signal, the driving circuit being connected to the processing circuit and the power amplifying circuit, the driving circuit regulating signal frequency based on the frequency regulation signal and the driving circuit regulating power of the power amplifying circuit for feeding back and controlling the alternate-current signal transmitted by the resonance circuit to provide stabilized power of the alternate-current signal.

6. The dual-sided wireless charging device as claimed in claim 4, wherein the power amplifying circuit and the resonance circuit are combined as a power integration circuit.

7. The dual-sided wireless charging device as claimed in claim 6, wherein the power integration circuit comprises a circuit composed of at least two metal oxide semiconductor field effect transistors.

8. The dual-sided wireless charging device as claimed in claim 7, wherein the power integration circuit comprises one of a half-bridge power circuit and a full-bridge power circuit.

9. The dual-sided wireless charging device as claimed in claim 1, wherein the receiver circuit comprises a detection resonance circuit, a control circuit, and a rechargeable battery, the detection resonance circuit receiving the alternate-current signal transmitted by the transmitter circuit, the control circuit being connected to the detection resonance circuit, the control circuit converting the alternate-current signal received by the detection resonance circuit into electrical power and performing voltage regulation of the electrical power, the rechargeable battery being connected to the control circuit, the rechargeable battery storing the electrical power converted by the control circuit.
